(19) United States
(12) Patent Application Publication
(10) Pub. No.: US 2004/0043166 A1
(43) Pub. Date: Mar. 4, 2004

(54) Release coating for food casing

(76) Inventor: Harsh Gopal, Danville, IL (US)

Correspondence Address: FISH & RICHARDSON P.C., 5000 BANK ONE CENTER, 1717 MAIN STREET, DALLAS, TX, 75201, US

(21) Appl. No.: 10/229,490

(22) Filed: Aug. 27, 2002

(51) Int. Cl. A22C 13/00; B05D 1/36; B05D 7/22

(52) U.S. Cl. 428/34.8; 427/230; 427/402

(57) ABSTRACT

The present invention provides a food casing that is coated with a composition which offers a wide application range in respect of easy peelability from goods of various compositions. It is also an object of the invention to provide a process for producing a food casing.

### FIELD OF THE INVENTION

The present invention relates to a tubular food casing having a coating on its inner surface, which provides improved peelability properties. Also disclosed is a process for producing this casing.

### BACKGROUND OF THE INVENTION

Casings coated with release coatings are known in the art. Casings composed of regenerated cellulose and having an internal coating composed of a water-soluble, film-forming carrier substance (starch and cellulose alkyl ether) and a high-molecular weight aliphatic hydrocarbon (paraffin wax, natural fats or oils), in order to more easily peel the casing from sausage mixtures, are also known in the art. This known coating emulsion has a disadvantage in that casings provided therewith are easily damaged during the shirring process or cannot be shirred at all. A further disadvantage is that the casing exhibits a tendency to stick to the shirring mandrel when compressed. Yet another disadvantage of this internal coating resides in the difficulty in handling hard paraffin during application to the internal surface of the sausage casing. In order to liquefy the paraffin, it must first be heated to temperatures of between 60°-70° C. prior to application, and then applied while hot. This procedure runs the risk of making the casing material too dry and becoming brittle. Furthermore, starch and cellulose ethers have thus far not been used as releasing agents, but merely as carrier substances, in relatively small amounts.

In order to improve the peelability of casings based on cellulose, other internal coatings comprised of water soluble starch ethers and triglycerides (U.S. Pat. No. 4,248,900), cellulose ethers and cationic resins (U.S. Pat. No. 4,161,968) or cellulose ethers and castor, mineral or silicone oil (U.S. Pat. No. 3,898,348) have been also been described. All of the aforementioned patents are fully incorporated by reference herein,

Casings are also known, for example, which provide a coating comprising a mixture of a water-soluble cellulose ether, a wax, and an oil, or comprise cellulose ether and wax in addition to a chromium/fatty acid complex compound and a dialkylpolysiloxane. However, the hitherto known preparations used for improving the peelability of casings are not satisfactory, in particular when stuffed with leaner, low fat products. The problem has been found to be particularly acute for water-added meat products where macerated muscles are tumbled and/or allowed to stand for a prolonged period of time. This results in gelatinization of extracted proteins resulting in a minimal amount of free liquid. Due to the low water content, satisfactory results are not obtained when these meat products are stuffed into casings coated with the conventional coatings known in the art.

### SUMMARY OF THE INVENTION

It is an object of the present invention to provide a food casing that is coated with a composition which exhibits easy peelability from goods of various compositions. It is also an object of the invention to provide a process for producing a food casing. Another object of the invention is to provide an emulsion which can be used to coat the inner surface of a food casing so as to improve the peelability of the casing from its contents. In accomplishing the foregoing objectives, there has been provided, in accordance with one aspect of the invention, a food casing, wherein the inner surface of said casing is provided with a coating which improves the peelability of the casing from its contents, the coating optionally comprising one or more surfactants.

### DESCRIPTION OF EMBODIMENTS

An embodiment, of the present invention provides a method for treating a food casing to improve its peelability from the contents contained, comprising a sequential two-step process of coating the inner surface of the food casing, i.e, the surface which contacts the contents within the casing, with a first coating selected from the group consisting of alkylketenedimer, chromium complex of fatty acid and silicone, followed by the application of a second coating to said food casing wherein said second coating comprises liquid smoke and oil and has a pH of 2-11.

In an embodiment of the invention, a first coating applied to the inner surface of a food casing is selected from the group consisting of alkylketenedimer, chromium complexes of fatty acid, silicones and mixtures thereof The first coating is applied to the food casing at a coating weight of at least 40 mg/m². In certain embodiments of the invention, the first coating is applied to the casing at a coating weight preferably ranging from 100 mg/m² to 600 mg/m².

The use of alkenylketene dimer (AKD) provides release, slip, and anti-blocking properties to the surface to which it is applied. AKD works by covalent bonding with available nucleophiles, such as carboxyls, hydroxyls, amines, sulfides, or primary amides. Some of the commercially available forms of AKD include, Aquapel® 364, Aquapel® 752 (15% solids, cationic starch stabilized emulsion), Hercon® 70 (12.5% solids, cationic starch stabilized emulsion), Hercon® 79 (15% solids, cationic starch/resin stabilized emulsion), Precis® 787, Precis®) 2000 (26% solids, cationic starch stabilized emulsion) and Precis® 3000 (18% solids, cationic starch/resin stabilized emulsion). In certain embodiments of the invention, the AKD used is formed predominantly from long-chain alkyls having between 16 and 18 carbon atoms. These materials provide good release of the casing from the meat while being readily soluble and/or dispersible in the second coating of the invention.

In an embodiment of the invention, chromium complexes of fatty acids are used as the first coating. In certain embodiments of the invention, the fatty acids complexed with chromium range in length from C₁₄ to C₁₈. Other embodiments of the invention use silicone fluids in the first coating. In certain embodiments of the invention, the silicone fluid is a linear chain of polydimethylsiloxane (PDMS). These linear chains have a wide range of chain lengths and molecular masses. As used herein, the term “polydimethylsiloxane” is intended to encompass linear chains of PDMS as well as cyclic polydimethylsiloxanes, which are formed as intermediates in the manufacture of the linear chain fluids.

As used herein, the term “food casing” is intended to encompass fibrous casings, non-fibrous casings, cellulose-based casings, non-cellulose-based casings, hydrated gel casings, dried casings and synthetic casings comprising nylon or polyester. Typical of coatable food casing materials are nylon, polyester, polyvinylidene chloride polymers and copolymers (saran), polyacetate and combinations thereof Other casing materials that may be used are amylose, polyvinyl alcohol, regenerated cellulose, natural casings and collagen. The casings further typically may have inner or outer barrier coats and reinforcing materials. Casings believed particularly suitable for the invention are natural casings, collagen, regenerated cellulose and regenerated cellulose reinforced with fibrous cellulose paper or other reinforcing material, with or without a barrier coating. In an embodiment of the invention, a preferred food casing is strippable regenerated cellulose.

In an embodiment of the invention, a liquid smoke comprising a solution of natural wood smoke constituents, is used in a second coating that is applied to a food casing treated with a first coating as discussed above. The amount of liquid smoke used depends upon (1) the color index (intensity) of smoke used and the color desired for the final product; and, (2) the moisture content of the liquid smoke used. The moisture content of the liquid smoke must be sufficient to yield a final casing moisture content of at least 15 g/100 g of cellulose. In an embodiment of the invention, the final casing moisture content ranges from 15 g/100 g of cellulose to 40 g/100 g of cellulose. The liquid smoke is produced by the limited burning of hardwoods and the absorption of the smoke so generated into an aqueous solution under controlled conditions. The limited burning keeps some of the undesirable hydrocarbon compounds or tars in an insoluble form, thereby allowing removal of these constituents from the final liquid smoke. Thus, by this procedure, the desirable wood constituents are absorbed into the solution in a balanced proportion and the undesirable constituents may be removed. The resultant liquid smoke solution is representative of the whole preferred spectrum of smoke colors and flavors without a preference of any one type. The apparatus and method for manufacturing typical liquid smokes of the preferred type is more fully described in U.S. Pat. No. 3,106,473 and U.S. Pat. No. 3,873,741, which are fully incorporated by reference herein.

Certain liquid smokes have been approved for use in foods by the U.S. Food and Drug Administration and the Meat Inspection Division of the U.S. Department of Agriculture. Exemplary of suitable commercially available liquid smokes are CHARSOL from Red Arrow Products Co., Manitowoc, Wis.; LIQUID HICKORY SMOKE from Hickory Specialties, Inc.; GRIFFITH'S NATURAL SMOKE FLAVOR from Griffith Laboratories Inc.; and SMOKAROMA LIQUID SMOKE CODE 10 from Meat Industry Suppliers, Inc.

Liquid smoke often is a solution of natural wood smoke constituents prepared by burning a wood, for example, a hickory or a maple, and capturing the natural smoke constituents in a liquid medium such as water. Alternatively, the liquid smoke to be used may be derived from the destructive distillation of a wood, that is, the breakdown or cracking of the wood into various compounds which are distilled out of the wood residue. Unmodified liquid smokes are generally very acidic, usually having a pH of 2.5 or less and titratable acidity of at least 3%, although some partially neutralized liquid smokes, having a pH up to about 5, are also available. Reference to the phrase “natural liquid smoke” or “conventional or commercial liquid smoke”, as used throughout this specification and in the appended claims with respect to materials for forming the basic liquid smoke compositions and casings of the invention, is intended to refer to, and should be understood as referring to, the smoke coloring and flavoring constituents and proportions thereof of liquid smoke solutions in their present commercially available form. The commercially available liquid smokes may include modifiers to change the taste or other properties of the natural liquid smokes.

In certain embodiments of the invention, liquid smoke solutions ranging in pH from 2-11 are used. In certain embodiments of the invention, the preferred pH range for acidic smoke solutions ranges from about 4 to about 6.5, and the preferred range for alkaline smoke solutions ranges from about 8 to about 11. As discussed above, unmodified liquid smoke solutions typically display a pH of 2.5 or less. A water-soluble alkalizing agent may be used to raise the pH of an acidic liquid smoke solution. Typical of water-soluble alkaline materials are ammonium hydroxide, potassium hydroxide, sodium carbonate, sodium bicarbonate and combinations thereof. Sodium carbonate and sodium bicarbonate may also act as buffers. A preferred material for utilization in the invention has been found to be sodium hydroxide at high concentrations as this provides good alkalization of the liquid smoke solution without increasing the aqueous bulk of the basic liquid smoke significantly.

In other embodiments of the invention, the pH range of the liquid smoke solution used in the second coating is greater than 8.

In an embodiment of the invention, the second coating comprises oil in addition to the liquid smoke solution. In an embodiment of the invention the oil used in the second coating comprises fatty acids having between 8 and 22 carbon atoms. The term “oil” as used herein refers to natural oils extracted from plant and animal sources, as well as synthetic oils. In an embodiment of the invention, the oil used in the second coating is a vegetable oil. In other embodiments of the invention, the vegetable oil is derived from cottonseed or soy bean. A commercial example of a vegetable oil that is suitable for use in the present invention is Durkex 500. In an embodiment of the invention the amount of oil in the second coating is present in an amount ranging from about 200 to about 4500 mg/m². In other embodiments of the invention, the amount of oil in the second coating ranges from about 550 to about 1100 mg/m².

In certain embodiments of the invention, the second coating further comprises one or more surfactants in addition to oil and liquid smoke. Surfactants (also known as emulsifiers) assists oil-containing components to remain in a stable emulsion with aqueous components. Surfactant functionality is the result of their chemical structure, which consists of two parts, a lipophilic hydrocarbon chain and a hydrophilic polar group. The surfactants used in certain embodiments of the invention have a hydrophilic/lipophilic balance (HLB value) ranging from about 3 to about 15. The HLB value indicates a surfactant's relative overall attraction to either oil or water. A low HLB indicates a strongly lipophilic emulsifier, while a high HLB value indicates one that is strongly hydrophilic. In an embodiment of the invention, the surfactants are non-ionic surfactants. In certain embodiments of the invention the one or more surfactants have a HLB value ranging from about 3 to about 13.5.

In certain embodiments of the invention, the one or more surfactants are selected from the group consisting of polyglyceryl esters and polyethoxylated sorbitan esters. Preferred polyglyceryl esters include but are not limited to triglycerylmonooleate (commercially sold as PGK 31K; HLB=˜6.2), triglyceryltetraoleate (commercially sold as Santone 3,4,O; HLB=˜3.0), hexaglycerylmonooleate (HLB=˜8.5), hexaglyceryldioleate (HLB=˜6.0), decaglyceryltetraoleate (HLB=˜6.0) and decaglyceryldecaoleate (HLB=˜3.0). Preferred polyethoxylated sorbitan esters include, but are not limited to, polyethoxy (20) sorbitan tri-stearate (commercially sold as T-Maz 65K; HLB=˜10.5), and ethoxylated mon- or diglycerides having a HLB=˜13.5.

In an embodiment of the invention, the one or more surfactants that are optionally present in the second coating, are present in an amount ranging from 0 to about 4000 mg/m². In other embodiments of the invention, the surfactants are present in an amount ranging from about 20 to about 3080 mg/m².

An embodiment of the invention provides a food casing coated with a release mixture on its inner surface i.e., the surface which contacts the contents of the casing, comprising a first coating selected from the group consisting of alkylketenedimer, chromium complex of fatty acid and silicone fluids; and a second coating comprising liquid smoke and oil, having a pH of 2-11.

The following examples are offered to illustrate several embodiments of the invention and should not be construed to limit the invention as described herein.

### EXAMPLES

Table 1 illustrates several examples of the release coating compositions used in the practice of the present invention. The test compositions in Table 1 comprise AKD in addition to the listed components. The “% meat pulled” value is ascertained by a visual inspection of the casing following a “pull test”, where a casing is separated from the contents. This value is used as a visual gauge to ascertain the release properties i.e., peelability of a coating composition.

TABLE 1

| Loading (mg/m²) | | | |
|---|---|---|---|
| Santone | T-Maz | PGO | % Meat |

| | | | | | | |
|---|---|---|---|---|---|---|
| Test # | 3, 4, O | 65K | 31K | Durkex 500K | Total | Pulled |

| | | | | | | |
|---|---|---|---|---|---|---|
| 1A | ˜20 | 0 | 0 | 1100 | ˜1100 | 0 |
| 2B | ˜20 | 0 | 440 | 1100 | ˜1550 | 0 |
| 3C | ˜20 | 440 | 0 | 1100 | ˜1550 | 0 |
| 4D | ˜20 | 440 | 440 | 1100 | ˜2000 | 0 |
| 5E | 2200 | 0 | 0 | 1100 | ˜3300 | 0 |
| 6F | 2200 | 0 | 440 | 1100 | ˜3750 | 0 |
| 7G | 2200 | 440 | 0 | 1100 | ˜3750 | 0 |
| 8H | 2200 | 440 | 440 | 1100 | ˜4200 | 0 |
| 9I | 1100 | 220 | 220 | 1100 | ˜2250 | 0 |
| 10J | 1100 | 220 | 220 | 0 | ˜1550 | 0 |
| 23I | 550 | 110 | 110 | 550 | ˜1300 | 0 |
| 24J | 550 | 110 | 110 | 550 | ˜1300 | 0 |

Table 2 illustrates a comparison of the “% meat pulled” value for the compositions described in claim 1 in the presence and absence of AKD.

TABLE 2

% Meat Pulled

| Test # | −AKD | +AKD |
|---|---|---|
| 1A | 45 | 0 |
| 4D | 5 | 0 |
| 5E | 5 | 0 |
| 8H | 10 | 0 |
| 9I | 10 | 0 |
| 10J | 40 | 0 |

Table 2 shows that the absence of AKD can be compensated for by an increase in the amount of surfactants in the coating composition. Coating compositions comprising increased amounts of one or more surfactants appeared to possess comparable release characteristics to the corresponding coating compositions comprising AKD.

The method of making and using the disclosed invention is described as comprising a number of acts or steps. These steps or acts may be practiced in any sequence or order unless indicated otherwise. Finally, any use herein of a numerical value, should be construed to mean approximate, regardless of whether the word “about” or “approximately” is used in describing the numerical value.

1. A method for treating a food casing to improve peelability of said casing from contents contained within, comprising,
coating the inner surface of the food casing with a first coating selected from the group consisting of alkylketenedimer, chromium complex of fatty acid, silicones and mixtures thereof; and,
applying a second coating to said food casing wherein said second coating comprises a solution of liquid smoke and oil and has a pH of 2-11.

2. The method of claim 1 wherein, said first coating is applied at a coating weight of at least 40 mg/m².

3. The method of claim 1 wherein said oil comprises fatty acids with chain lengths ranging from C₈ to C₂₂.

4. The method of claim 1 wherein said chromium complex comprises fatty acids ranging from C₁₄ to C₁₈.

5. The method of claim 1 wherein said food casing is selected from the group consisting of hydrated gel casings, dried casings and non-cellulose-based casings.

6. The method of claim 5 wherein said non-cellulose-based casing is made of nylon or polyester.

7. The method of claim 1 wherein said oil is present in an amount ranging from about 200 to about 4500 mg/m².

8. The method of claim 1 wherein said second coating further comprises one or more surfactants having a hydrophilic/lipophilic balance value ranging from about 3 to about 15.

9. The method of claim 8 wherein said one or more surfactants are selected from the group consisting of polyglyceryl esters and polyethoxylated sorbitan esters.

10. The method of claim 9 wherein said polyglyceryl ester is selected from the group consisting of triglycerylmonooleate, triglyceryltetraoleate, hexaglycerylmonooleate, hexaglyceryldioleate, decaglyceryltetraoleate and decaglyceryldecaoleate.

11. The method of claim 3 wherein said oil is a vegetable oil.

12. The method of claim 11, wherein said vegetable oil is derived from soy bean or cottonseed.

13. The method of claim 8 wherein said one or more surfactants are each present in an amount ranging from 0 to about 4000 mg/m².

14. A food casing coated with a release mixture on its inner surface comprising,
a first coating selected from the group consisting of alkylketenedimer, chromium complex of fatty acid and silicone fluids; and,
a second coating comprising liquid smoke and oil, having a pH of 2-11.

15. The method of claim 14 wherein, said first coating is applied at a coating weight of at least 40 mg/m².

16. The casing of claim 15 wherein said oil comprises fatty acids with chain lengths ranging from C₁₈ to C₂₂.

17. The casing of claim 15 wherein said chromium complex comprises fatty acids ranging from C₁₄ to C₁₈.

18. The casing of claim 15 wherein said food casing is selected from the group consisting of hydrated gel casings, dried casings and non-cellulose-based casings.

19. The casing of claim 18 wherein said non-cellulose-based casing is made of nylon or polyester.

20. The casing of claim 14 wherein said oil is present in an amount ranging from about 500 to about 4500 mg/m².

21. The casing of claim 14 wherein said second coating further comprises one or more surfactants having a hydrophilic/lipophilic balance value ranging from about 3 to about 15.

22. The method of claim 21 wherein said one or more surfactants are selected from the group consisting of polyglyceryl esters or polyethoxylated sorbitan esters.

23. The method of claim 22 wherein said polyglyceryl ester is selected from the group consisting of triglycerylmonooleate, triglyceryltetraoleate, hexaglycerylmonooleate, hexaglyceryldioleate, decaglyceryltetraoleate and decaglyceryldecaoleate.

24. The method of claim 16 wherein said oil is a vegetable oil.

25. The method of claim 24, wherein said vegetable oil is derived from soy bean or cottonseed.

26. The method of claim 21 wherein said one or more surfactants are each present in an amount ranging from 0 to about 4000 mg/m².
